(19) United States
(12) Patent Application Publication
(10) Pub. No.: US 2023/0123475 A1
(43) Pub. Date: Apr. 20, 2023

(54) METHOD AND SYSTEM FOR END-TO-END ENCRYPTION OF COMMUNICATIONS OVER A NETWORK

(71) Applicant: AT&T Intellectual Property I, L.P., Atlanta, GA (US)

(72) Inventor: Lars Benjamin Johnson, Brooklyn, NY (US)

(73) Assignee: AT&T Intellectual Property I, L.P., Atlanta, GA (US)

(21) Appl. No.: 17/504,563

(22) Filed: Oct. 19, 2021

(51) Int. Cl. H04W 12/033; H04W 12/06; H04W 12/041; H04W 12/0431

(52) U.S. Cl. CPC H04W 12/033; H04W 12/06; H04W 12/041; H04W 12/0431

(57) ABSTRACT

Aspects of the subject disclosure may include, for example, receiving a command to initiate encrypted communications between a device and a second device, providing information regarding the device to a network operator system for device authentication, obtaining confirmation of device authentication from the network operator system, generating first encryption data, causing a portion of the first encryption data to be transmitted to the second device, obtaining, from the second device, a portion of second encryption data generated based on confirmation of authentication of the second device, and conducting the encrypted communications with the second device by causing first communication data, for the second device, to be encrypted using the portion of the second encryption data, receiving second communication data that is encrypted using the portion of the first encryption data, and decrypting the second communication data using a different portion of the first encryption data. Other embodiments are disclosed.

### FIELD OF THE DISCLOSURE

The subject disclosure relates to end-to-end encryption of communications over a network.

### BACKGROUND

Various (e.g., third-party) applications (or apps) are available today that allow users to make encrypted voice over Internet Protocol (VoIP) calls. Users generally trust that the encryption is as secure as advertised, unless or until security tests fail or security is exposed. Mobile devices today additionally include native messaging apps that facilitate short message service (SMS)/multimedia message service (MMS) messaging, and the devices generally support third-party apps that offer messaging between users as well, although the same app needs to be used for such messaging.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2C are block diagrams illustrating an example, non-limiting embodiment of a system functioning within, or operatively overlaid upon, the communications network of FIG. 1 in accordance with various aspects described herein.

FIGS. 2D-2G are block diagrams illustrating an example, non-limiting embodiment of a system functioning within, or operatively overlaid upon, the communications network of FIG. 1 in accordance with various aspects described herein.

FIG. 2H depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

Current communication (e.g., calling or messaging) services/apps do not assure a user of the identity of an individual that the user is communicating with. With spoofing (e.g., SMS spoofing), therefore, a user may not know the true identity of who is actually texting with, or talking to, the user at the other end. Additionally, there is little to no assurance that any encryption that might be provided by such apps is truly end-to-end.

The subject disclosure describes, among other things, illustrative embodiments of communications encryption in which a network-based authentication system is leveraged to facilitate end-to-end encryption of communications (e.g., calls and/or messages) between users over a network. The network-based authentication system may include a platform, such as one of the exemplary platforms described herein or others, that is capable of providing mobile identity and authentication services, such as mobile/user identity verification via network operator authentication of subscriber accounts or subscriber identity modules (SIMs).

In exemplary embodiments, a user device, such as a mobile phone, a tablet, or the like, may be equipped with a communications app (e.g., a voice/video calling and/or messaging app) as well as an authentication app that functions as a device-side client of the network-based authentication system. In various embodiments, the authentication app may be configured to interface with a server side of the network-based authentication system, which may include authentication-related functionality implemented in one or more server devices, such as an authentication server, network provider server(s), and/or the like for facilitating mobile/user identity verification. In one or more embodiments, handshaking between the user device and a counterparty user device can be effected based upon identity verification of the user devices by the network-based authentication system, thus enabling end-to-end encrypted calling/messaging between the user devices. In certain embodiments, the authentication server may be communicatively coupled with (or authentication server functionality may be included in) provider servers corresponding to different network providers, which can enable user devices associated with the different network providers to engage in end-to-end encrypted communications.

In exemplary embodiments, a user interface of the communications app may include a user selectable option for triggering call/message encryption. The communications app may, based on upon selection of the option by a user of the user device, cause the authentication app to facilitate the aforementioned identity verification and handshaking. Identity verification, or authentication, may include verification of the user device, an identity of the user of the user device, the phone number associated with the user device, and/or the like.

In the case of a voice calling session between a first user of a first user device and a second user of a second user device, for example, the authentication app on the first user device may cause a first portion of the handshake to be transmitted to the second user device (e.g., via the authentication server and/or network provider server(s) associated with the first and second user devices, and over a data communication channel of the network), which may trigger presentation of a confirmation prompt on the second user device. Based upon receiving the second user's confirmation at the second user device to encrypt the call, an authentication app on the second user device may facilitate authentication of the second user device, and complete the handshake, enabling encryption of data pertaining to the call at each of the two devices (e.g., prior to such data being communicated over VoIP).

In a case where communications is via messaging (e.g., SMS messaging, MMS messaging, or other (e.g., similar) type of messaging), messages can be made to be decodable by (e.g., only by) intended users over a network. Here, the aforementioned user selectable option may include a signed message option. Upon detecting user selection of that option on the first user device, for example, the authentication app thereon may instantiate a handshake with, or otherwise cause a first portion of the handshake to be transmitted to the second user device (e.g., via the authentication server and/or network provider server(s) associated with the first and second user devices, and over a data communication channel of the network), which may trigger presentation of a confirmation prompt on the second user device. Based upon receiving the second user's confirmation at the second device to engage in encrypted messaging, an authentication app on the second user device may facilitate authentication of the second user device, and complete the handshake, enabling encryption/decryption of messages (e.g., signing and/or countersigning of messages) at each of the two devices.

In one or more embodiments, the handshaking can result in generation of an encryption function (e.g., for one-time use or for use in the present communication session and one or more future communication sessions between the first user device and the second user device) that allows for communication of encrypted call data and/or messages with a verified counterparty associated with a counterparty user device or phone number.

With increasing adoption of communications networks for user-to-user communications, users/subscribers will have higher demands for protection of their data, calls, and conversations, and for assurance that calls/messages they receive are indeed from expected originators and that outgoing calls/messages are directed (e.g., only) to intended recipients. Providing a mechanism for facilitating identity verification in user-to-user communications (e.g., calling and/or message) over a network assures that who a user is communicating with at the other end is truly the expected party, which enhances the safety/security of communications and overall user experience. For instance, a malicious actor who may be listening in to a conversation (e.g., by operating from a spoofed phone number) would not be privy to a handshake, as described herein, and thus would be unable to decrypt messages that are encrypted as a result of the handshake.

Leveraging network-based authentication system(s) and network provider(s) to create/facilitate handshakes for end-to-end encrypted calling, as described herein, makes it possible—e.g., in a case where an ongoing voice call is to be encrypted—for a user device to effect switching of the call to an encrypted VoIP call with minimal user intervention and without needing to utilize a third-party app to effect the transition. This improves the safety/security of communications and enhances overall user experience. Providing a device-native mechanism (or environment) for facilitating instantiation of end-to-end encrypted calling reduces or eliminates user/subscriber reliance on (e.g., untrusted) third-party apps that lack end-to-end encryption and/or identity verification capabilities, which further improves the safety/security of communications and enhances overall user experience. Embodiments described herein also hinder spoofing, hacking, or the like, which reduces the amount of traffic associated with such malicious activities that networks might otherwise undesirably bear, thereby improving overall network performance. Implementing the various embodiments described herein such that they are usable for communications between users/subscribers associated with different network providers also promotes adoption of the network-based authentication system.

One or more aspects of the subject disclosure include a device, comprising a processing system including a processor, and a memory that stores executable instructions that, when executed by the processing system, facilitate performance of operations. The operations can include receiving a command to initiate end-to-end encrypted communications between the device and a second device. Further, the operations can include providing, over a network, information regarding the device to a network operator system for authentication of the device. Further, the operations can include obtaining, over the network and responsive to the providing the information, a confirmation of authentication of the device from the network operator system. Further, the operations can include generating first encryption data based on the obtaining the confirmation of authentication of the device. Further, the operations can include causing a portion of the first encryption data to be transmitted, over the network, to the second device. Further, the operations can include obtaining, over the network and from the second device, a portion of second encryption data that is generated based on a second confirmation of authentication of the second device. Further, the operations can include conducting the end-to-end encrypted communications with the second device by causing first communication data, directed to the second device, to be encrypted using the portion of the second encryption data, receiving, over the network, second communication data that is encrypted using the portion of the first encryption data, and decrypting the second communication data using a different portion of the first encryption data.

One or more aspects of the subject disclosure include a non-transitory machine-readable medium, comprising executable instructions that, when executed by a processing system of a mobile device including a processor, facilitate performance of operations. The operations can include receiving a request to initiate end-to-end encrypted communications with a counterparty device. Further, the operations can include transmitting, over a network, information regarding the mobile device to a network operator system for verification of the mobile device. Further, the operations can include receiving, over the network and responsive to the transmitting the information, a confirmation of verification of the mobile device from the network operator system. Further, the operations can include deriving encryption data based on the receiving the confirmation of verification of the mobile device. Further, the operations can include performing, over the network, a handshake with the counterparty device based on the encryption data. Further, the operations can include conducting the end-to-end encrypted communications with the counterparty device based on the performing the handshake, thereby avoiding unauthorized deciphering of the communications by any third-party devices.

One or more aspects of the subject disclosure include a method. The method can comprise obtaining, by a processing system including a processor, and from a first user device, information regarding the first user device for authentication of the first user device, wherein the obtaining the information is responsive to a user request at the first user device to initiate encrypted calling or messaging between the first user device and a second user device. Further, the method can include performing, by the processing system, authentication of the first user device based on the information. Further, the method can include, responsive to the performing the authentication of the first user device, providing, by the processing system, and to the first user device, a confirmation of authentication of the first user device, wherein the providing the confirmation of authentication enables the first user device to exchange encryption data with the second user device to facilitate the encrypted calling or messaging with the second user device.

Other embodiments are described in the subject disclosure.

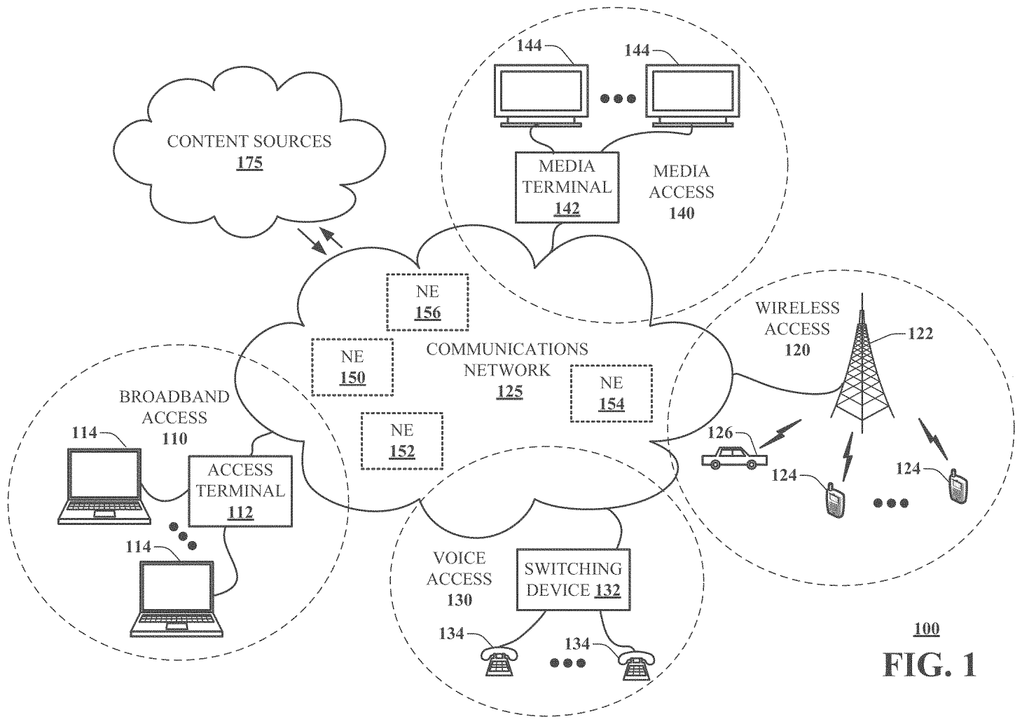

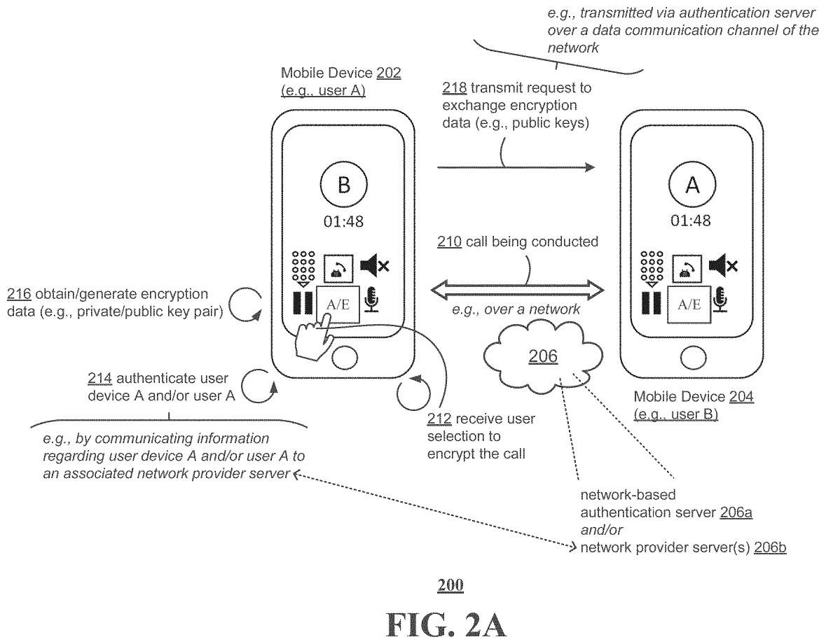

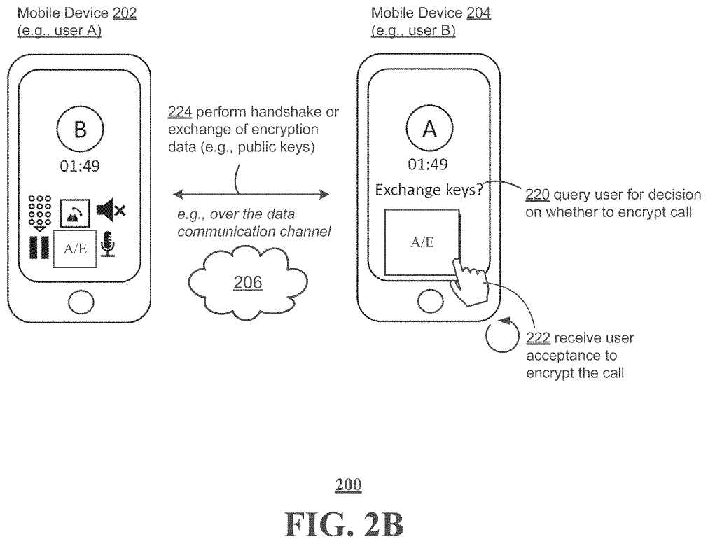

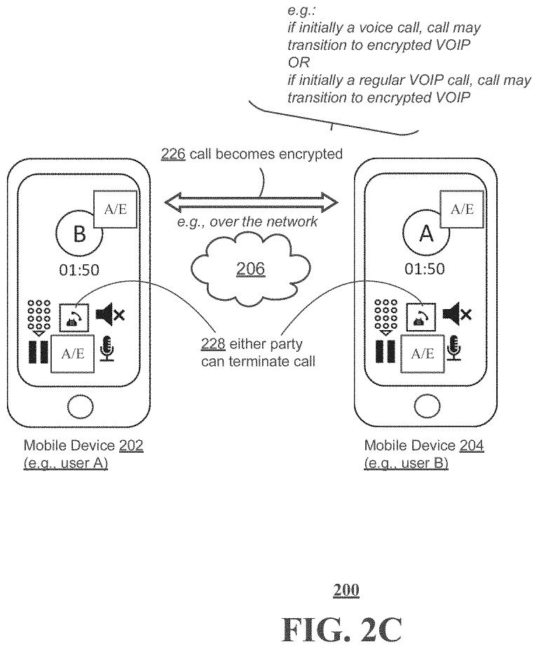

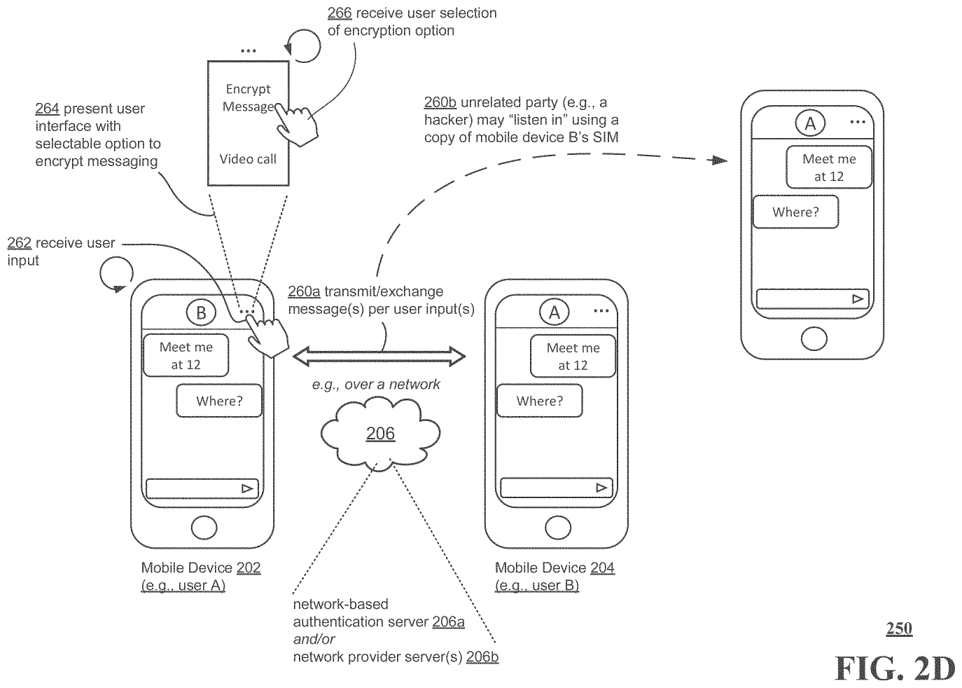

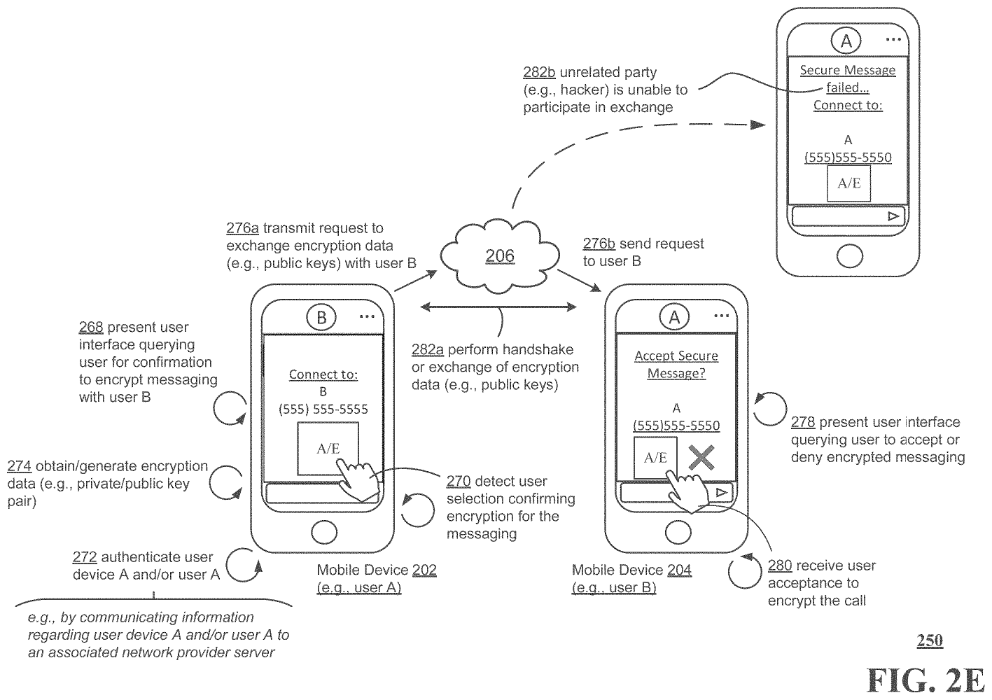

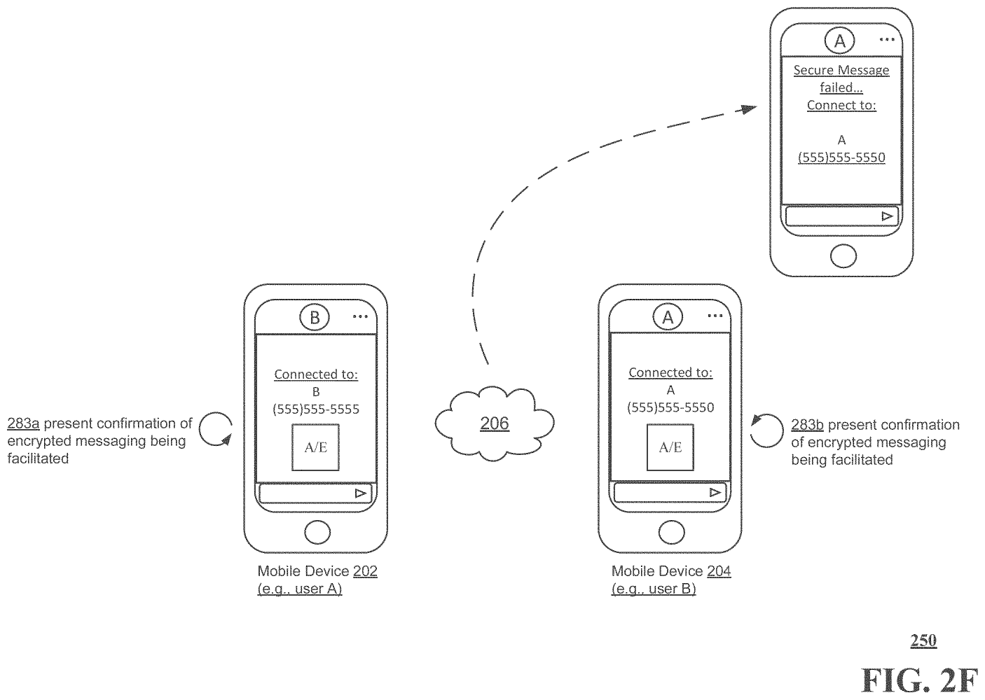

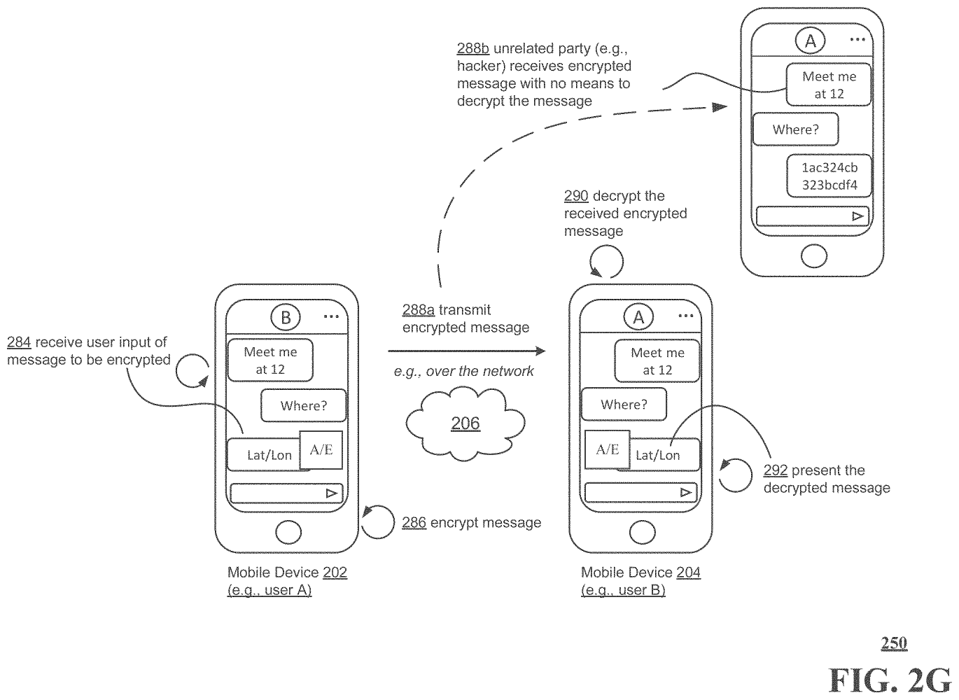

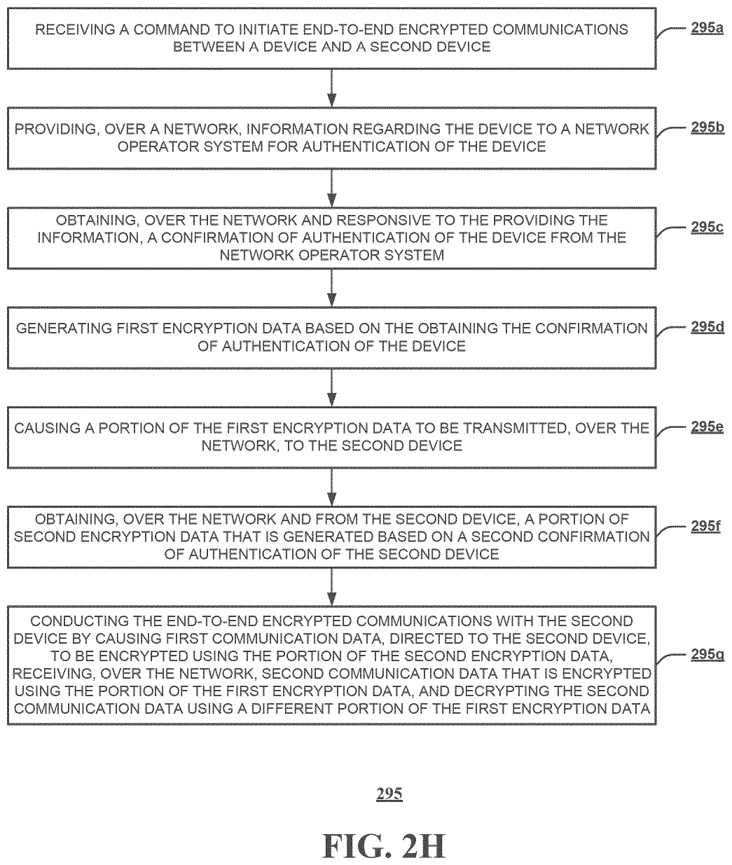

Referring now to FIG. 1, a block diagram is shown illustrating an example, non-limiting embodiment of a system 100 in accordance with various aspects described herein. For example, system 100 can facilitate, in whole or in part, end-to-end encryption of communications over a network, such as that described herein with respect to FIGS. 2A-2G. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIGS. 2A-2C are block diagrams illustrating an example, non-limiting embodiment of a system 200 functioning within, or operatively overlaid upon, the communications network 100 of FIG. 1 in accordance with various aspects described herein. FIGS. 2D-2G are block diagrams illustrating an example, non-limiting embodiment of a system 250 functioning within, or operatively overlaid upon, the communications network 100 of FIG. 1 in accordance with various aspects described herein.

In exemplary embodiments, a mobile device (e.g., mobile device 202) can leverage a network-based authentication system to facilitate generation of key(s)/token(s) that are usable for encrypting communications—e.g., calls and/or messages. The network-based authentication system may, as part of authenticating the mobile device or user of the mobile device, coordinate with a network provider associated with the mobile device to verify an identity of the mobile device or user based on subscriber/device/account information.

In various embodiments, a user of a mobile device (e.g., user A of mobile device 202) may (e.g., initially) register with the network-based authentication system, which may enable a corresponding authentication app on the mobile device to facilitate verification of the mobile device or the user when needed, such as when the user desires to encrypt voice/video calls and/or messages. Registration may, for example, involve a system of an associated network provider enabling a setting in the user's subscriber account to permit utilization of the identity verification feature of the network-based authentication system for the user and/or the mobile device. When registered, the authentication app may—e.g., based upon detection of the user's selection to encrypt voice/video calls and/or messages—obtain information regarding the user and/or the mobile device (e.g., the user's name, SIM data stored in the mobile device, location data associated with the mobile device, data regarding a network access point to which the mobile device is communicatively coupled, biometric information of the user, and/or the like), and provide the information to the network provider's system for identity verification.

As a brief overview of the implementation shown in FIGS. 2A to 2C (which is described in more detail below), in one example, users A and B may desire to communicate with one another via an encrypted voice call. Here, user A can input, on corresponding mobile device 202, a command to encrypt the call. This can trigger the authentication system/app to authenticate the mobile device 202 and/or the user A, and obtain, generate, and/or provide first key(s)/token(s) (e.g., a private/public key pair) for use with encrypting the call. The mobile device 202 can cause a first public key/token to be transmitted to a mobile device 204 that corresponds to user B, and can receive, from the mobile device 204, a second public key/token obtained or generated based on a similar authentication of the mobile device 204 and/or the user B. The mobile device 202 can then encrypt data relating to the voice call using the second public key/token, and the mobile device 204 can similarly encrypt data relating to the voice call using the first public key/token, thereby providing secure, end-to-end communications between users A and B.

The above-described technique can be similarly applied for messaging between users A and B, as shown in FIGS. 2D to 2G (which is described in more detail below). For instance, an input command from user A to a messaging app on mobile device 202 can trigger authentication of the mobile device 202 and/or the user A and first key(s)/token(s) (e.g., a private/public key pair) to be obtained and/or generated. The mobile device 202 can cause a first public key/token to be transmitted to the mobile device 204, and can receive, from the mobile device 204, a second public key/token obtained and/or generated based on a similar authentication of the mobile device 204 and/or the user B. The mobile device 202 can then encrypt data relating to the messaging using the second public key/token, and the mobile device 204 can similarly encrypt data relating to the messaging using the first public key/token, thereby similarly providing secure, end-to-end communications between users A and B.

Referring first to FIGS. 2A to 2C in detail, the system 200 can include mobile device 202 (e.g., corresponding to a user A), mobile device 204 (e.g., corresponding to a user B), and a network 206. Each of the mobile devices 202, 204 can include a communication/computing device, such as a mobile phone (e.g., a smart phone, a radiotelephone, etc.), a wearable communication device (e.g., a smart wristwatch, a pair of smart eyeglasses, media-related gear (e.g., augmented reality (AR), virtual reality (VR), or mixed reality (MR) glasses and/or headset/headphones), etc.), a similar type of device, or a combination of some or all of these devices. The network 206 may include one or more wired and/or wireless networks. For example, the network 206 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks. As depicted, the network 206 may include a network-based authentication server 206a and network provider server(s) 206b. In exemplary embodiments, the authentication server 206a may be configured to communicate with respective authentication apps executing on mobile devices, such as the mobile devices 202, 204. In various embodiments, the network provider server(s) 206b may include servers corresponding to one or more network providers associated with mobile devices, such as a first network provider associated with the mobile device 202, a second network provider associated with the mobile device 204 (which may be the same as or different from the first network provider), and so on. In certain embodiments, the network-based authentication server 206a may be communicatively coupled with (or authentication server functionality may be included in) one or more network provider server(s) 206b.

As shown by reference number 210 in FIG. 2A, a call may be facilitated (e.g., ongoing) between the mobile device 202 and the mobile device 204 over the network 206. Here, the call may be conducted via respective communications apps (e.g., voice/video calling apps) operating on mobile devices 202, 204. As shown by reference number 212, the mobile device 202 may receive a selection (e.g., from user A) to encrypt the call, such as a depressing of icon A/E, although other user interfaces and user interaction techniques can be utilized as described herein. In various embodiments, the mobile device 202 may present a user interface that includes an encryption option for user selection. In exemplary embodiments, the encryption option may correspond to, or be associated with functionality provided by, an authentication app of a network-based authentication system. In various embodiments, the selection may cause the authentication app to identify an intended contact and/or phone number—i.e., in this case, contact information/the phone number associated with the user B/mobile device 204—and determine that the encrypted call is to be conducted with the corresponding device.

Although FIG. 2A shows the encryption option as being visually presented, it is to be appreciated and understood that presentation of the encryption option, or of any user selectable option or associated user interface described herein, can be presented in any suitable manner, such as, for example, audibly, haptically, and/or the like. Additionally, although FIG. 2A shows the user selection of the encryption option as being performed by touching a display of the mobile device 202, it is also to be appreciated and understood that the selection of the encryption option, or of any user selectable option described herein, can be performed in any suitable manner, such as, for example, via a voice command, via a gesture, and/or the like. Also, in some cases, there may not yet be an ongoing call between mobile devices 202 and 204. In these cases, the user A may identify an intended recipient of a call (e.g., user B, user B's phone number, or the like) and select the encryption option for that call.

As shown by reference number 214, the mobile device 202 may facilitate authentication of user A and/or the mobile device 202. In various embodiments, this may include the authentication app thereon obtaining information regarding the user A and/or the mobile device 202 (e.g., user A's name, SIM data (e.g., phone number, mobile device 202's serial number, and/or the like) stored in the mobile device 202, location data associated with the mobile device 202, data regarding a network access point to which the mobile device 202 is communicatively coupled, biometric information of user A, and/or the like), and providing the information to a network provider (e.g., a network provider server 206b) associated with the user A and/or the mobile device 202 for identity verification.

As shown by reference number 216, the mobile device 202 (e.g., the authentication app thereon) may obtain/generate encryption data (e.g., a private/public key pair) to be used for call encryption. In various embodiments, the authentication app may obtain/generate the encryption data based upon receiving confirmation from the network provider (e.g., a network provider server 206b) that the user A and/or the mobile device 202 have been verified.

As shown by reference number 218, the mobile device 202 (e.g., the authentication app thereon) may cause a request to exchange encryption data (e.g., public keys) to be transmitted to the mobile device 204. In one or more embodiments, the request may be transmitted (e.g., in the form of data/text message(s) or the like) via the authentication server 206a and/or the network provider server(s) 206b associated with the mobile devices 202, 204, and over a data communication channel of the network 206. In a case where the call is ongoing over a voice communication channel, the request may thus be transmitted separately from voice communications. In certain embodiments, the authentication server 206a and/or the network provider server 206b associated with the mobile device 202 can, based on user A's selection 212 to encrypt a call associated with a contact and/or phone number corresponding to the mobile device 204, use the contact information/phone number to identify (e.g., by performing one or more lookup or query operations) a network provider associated with the mobile device 204 (which may or may not be the same network provider associated with the mobile device 202), communicate with a corresponding network provider server 206b to trigger authentication of the mobile device 204 (or, where the mobile devices 202 and 204 are associated with the same network provider, such communication would not be necessary, and only triggering of the authentication may be performed), and cause the request to be transmitted to the mobile device 204 based upon authentication of the mobile device 204. Here, triggering authentication may involve causing an authentication app on the mobile device 204 to obtain information regarding the user B and/or the mobile device 204 (e.g., user B's name, SIM data (e.g., phone number, mobile device 204's serial number, and/or the like) stored in the mobile device 204, location data associated with the mobile device 204, data regarding a network access point to which the mobile device 204 is communicatively coupled, biometric information of user B, and/or the like), to provide the information to the network provider associated with the user B and/or the mobile device 204 for identity verification, and to obtain/generate encryption data (e.g., a private/public key pair) for the mobile device 204 based upon receiving confirmation from the network provider that the user B and/or the mobile device 204 have been verified. In some embodiments, the authentication server 206a and/or the network provider server 206b associated with the mobile device 202 may not trigger authentication of the mobile device 204, but may simply cause the request to be transmitted to the mobile device 204.

Referring to FIG. 2B, the mobile device 204 may, based upon receiving the request, present (220) a prompt on whether user B desires to participate in an encrypted call, and may receive (222) user B's acceptance to encrypt the call, such as a depressing of icon A/E, although other user interfaces and user interaction techniques can be utilized as described herein. In embodiments where authentication of the mobile device 204 has already been performed (e.g., as described above), the authentication app on the mobile device 204 may utilize the obtained/generated encryption data for handshaking purposes, as described below. In embodiments where authentication of the mobile device 204 has not yet been performed, the authentication app on the mobile device 204 may obtain/generate encryption data by triggering authentication of the mobile device 204 and/or the user B in a manner similar to that described above with respect to reference numbers 214 and 216 for the mobile device 202 and the user A. Authentication of the mobile device 204 and/or the user B can ensure that subsequent handshaking/exchanging of encryption data for the call will (e.g., only) be between the intended parties/devices—i.e., the mobile device 202 and the mobile device 204. It should be appreciated and understood, therefore, that in a scenario where a malicious actor uses a hacking device to spoof the phone number associated with the mobile device 204, makes a call to the mobile device 202 using the hacking device, and the user A of the mobile device 202 chooses to encrypt the call (e.g., to trigger authentication of the other party), the hacking device would not be authenticated by the network provider associated with the mobile device 204, and thus would not be able to participate in the handshaking/exchanging of encryption data for the call.

At 224, the mobile devices 202, 204 may perform a handshake or exchange of encryption data (e.g., respective public keys or signatures). In various embodiments, the mobile devices 202, 204 may perform the handshake/exchange via one or more tokens. In one or more embodiments, the exchange may be conducted (e.g., in the form of data/text message(s) or the like) via the authentication server 206a and/or the network provider server(s) 206b associated with the mobile devices 202, 204, over a data communication channel of the network 206. In a case where the call is ongoing over a voice communication channel, the data associated with the exchange may thus be transmitted separately from voice communications. In exemplary embodiments, handshaking may involve the authentication app on mobile device 202 signing exchange data using a private key (e.g., based on identity verification of the mobile device 202 by the network provider server 206b associated with the mobile device 202), and sending, via the network provider server(s) 206b associated with the mobile devices 202, 204, the exchange data to a device corresponding to the target recipient number (e.g., phone number). Here, the network provider server 206b associated with the target recipient number may identify the mobile device 204 (e.g., based upon prior registration of the mobile device 204 with the network-based authentication system), and provide the exchange data to the mobile device 204 to facilitate the handshake.

In certain embodiments, data relating to the handshake may be stored in (e.g., each of) the mobile devices 202, 204. In one or more embodiments, the handshaking can involve parties using one another's authentication system signature to “create” the handshake. In various embodiments, handshaking can result in generation of an encryption function for one-time use (e.g., for the present call or message/messaging session) or for use in the present communication session and for one or more future communication sessions between the parties (e.g., for some or all calls or messages/messaging sessions between the mobile devices 202, 204). In this way, a party may conduct encrypted calls and/or engage in encrypted messaging (e.g., as described in more detail below with respect to system 250 of FIGS. 2D-2G) with a counterparty associated with a verified/authenticated device or phone number. In some embodiments, the encryption function may expire after a period of time (e.g., several hours, several days, etc.) elapses, after which a subsequent handshake may be needed for another call or message/messaging session between the devices.

As shown by reference number 226 in FIG. 2C, the call may become encrypted. Here, for example, the mobile device 202 (e.g., the communications app and/or the authentication app operating on the mobile device 202) may, using encryption data for the mobile device 204 (e.g., a public key obtained as part of the handshake), encrypt voice-related data of the call intended for the mobile device 204, and the mobile device 204 (e.g., the communications app and/or the authentication app operating on the mobile device 204) may, using encryption for the mobile device 202 (e.g., a public key obtained as part of the handshake), encrypt voice-related data of the call intended for the mobile device 202. Continuing the example, the mobile device 202 (e.g., the communications app and/or the authentication app operating on the mobile device 202) may, using encryption data for the mobile device 202 (e.g., a private key for the mobile device 202), decrypt voice-related data of the call received from the mobile device 204, and the mobile device 204 (e.g., the communications app and/or the authentication app operating on the mobile device 204) may, using encryption data for the mobile device 204 (e.g., a private key for the mobile device 204), decrypt voice-related data of the call received from the mobile device 202.

In a case where the call was initially ongoing and facilitated over a voice communications channel, the call may be transitioned to an encrypted VoIP call on a data communications channel. For example, where the call is initially conducted over a 4G network (e.g., a voice call conducted over a voice-based channel), the call may be placed on hold and an encrypted VoIP session may be initiated and facilitated for the two devices over a data channel. Here, the 4G session may be suspended or terminated after the encrypted VoIP session is established or may remain on hold in case call encryption is deactivated and the call needs to resume over the 4G network. In a case where the call was initially ongoing and facilitated over a data channel as a VoIP call, the call may remain as a VoIP call, but may become encrypted. For example, where the call is initially conducted over a data channel as an unencrypted VoIP call, data packets of the VoIP call may become encrypted before being transmitted over the data channel.

As shown by reference number 228, either the user A or the user B may terminate the call. In various embodiments, a user may selectively deactivate encryption of the call (e.g., by selecting a corresponding option on the respective mobile device), which may (e.g., based upon presenting, on the counterparty mobile device, a query as to whether to end the encryption, and receiving, by the counterparty mobile device, confirmation to end the encryption) cause the mobile devices 202, 204 to halt performing encryption/decryption functions for the call, transition facilitation of the call to a voice communications channel (e.g., in a case where the call was initially conducted on the voice communications channel), and/or the like. User-selective deactivation of encryption can allow user(s) to manage system/data usage as needed, since encrypted calling may utilize more bandwidth/network resources than unencrypted calling.

Performing identity verification/authentication as part of (e.g., prior to or as a condition for) encrypting a call or message/messaging session provides enhanced communication security, particularly in a case where a first party is uncertain whether a second party on the other end is truly who the first party believes the second party to be. For instance, where a first party believes that a second party on the other end of a call is a particular party, but where the second party is actually a spoofer (or hacker), triggering of the encryption option by the first party would not result in successful handshaking between the first party's device and the second party's (spoofer's) device (and thus not result in successful encryption of the call), since the second party (spoofer), with no physical access to the particular party's mobile device and/or the like, would not be properly verified (e.g., by the particular party's network provider). For example, triggering of the encryption option by the first party may rather result in the network-based authentication system (and/or a network provider system associated with the first party) identifying a network provider system that is associated with the particular party's mobile device, and causing that network provider system to authenticate the particular party's mobile device, which would have no effect for the second party's (spoofer's) device. Here, the first party can, by virtue of unsuccessful handshaking for/encryption of the call, determine the illegitimacy of the call, and perhaps terminate it, without further risk of undesired exposure of personal information.

Referring now to FIGS. 2D to 2G in detail, the system 250 can be the same as or similar to the system 200. As depicted in FIG. 2D, for example, the system 250 can include the mobile device 202, the mobile device 204, and the network 206.

As shown by reference number 260a, the mobile devices 202 and 204 may transmit/exchange message(s) in accordance with user input(s). In various embodiments, the message(s) may be exchanged via respective communications apps (e.g., messaging apps) operating on mobile devices 202, 204. As depicted, an unrelated party (e.g., a malicious actor, such as a hacker or the like) may be able to participate (260b) in the messaging between the mobile devices 202, 204—e.g., by “listening in” to the conversation using a copy of the mobile device 204's SIM.

In a case where one of the users—e.g., user A—deems it necessary to protect the privacy of the messaging, the user may initiate message encryption. As shown by reference number 262, the mobile device 202 may receive a user input—e.g., to engage in encrypted messaging with the mobile device 204. The mobile device 202 may, based upon receiving the user input, present (264) a user interface with a selectable encryption option to encrypt messaging. As shown by reference number 266, the mobile device 202 may receive a user selection of the encryption option. In exemplary embodiments, the encryption option may correspond to, or be associated with functionality provided by, an authentication app of a network-based authentication system (e.g., similar to that described above with respect to system 200 of FIGS. 2A-2C). As shown in FIG. 2E, the mobile device 202 may, based upon receiving the user selection of the encryption option, query (268) the user for confirmation to engage in encrypted messaging with the mobile device 204. The mobile device 202 may detect (270) user confirmation to engage in encrypted messaging with the mobile device 204 (e.g., a depressing of icon A/E, although other user interfaces and user interaction techniques can be utilized as described herein), and may facilitate (272) authentication of user A and/or the mobile device 202. In various embodiments, any of 262, 266, and 270 may cause the authentication app to identify an intended contact and/or phone number—i.e., in this case, contact information/the phone number associated with the user B/mobile device 204—and determine that the encrypted messaging is to be conducted with the corresponding device. In one or more embodiments, authentication 272 may be similar to reference number 214 described above with respect to FIG. 2A. For instance, this may include the authentication app obtaining information regarding the user A and/or the mobile device 202 (e.g., user A's name, SIM data (e.g., phone number, mobile device 202's serial number, and/or the like) stored in the mobile device 202, location data associated with the mobile device 202, data regarding a network access point to which the mobile device 202 is communicatively coupled, biometric information of user A, and/or the like), and providing the information to a network provider associated with the user A and/or the mobile device 202 for identity verification.

As shown by reference number 274, the mobile device 202 (e.g., the authentication app thereon) may obtain/generate encryption data (e.g., a private/public key pair) to be used for encrypted messaging. In various embodiments, this may be similar to reference number 216 described above with respect to FIG. 2A. For instance, the authentication app may obtain/generate the encryption data based upon receiving confirmation from the network provider that the user A and/or the mobile device 202 has been verified.

As shown by reference numbers 276a, 276b, the mobile device 202 may cause a request to be transmitted to the mobile device 204. The request may include a request to exchange encryption data (e.g., respective public keys or signatures) with the mobile device 204. In exemplary embodiments, the request may be transmitted (e.g., in the form of data/text message(s) or the like) via the authentication server 206a and/or the network provider server(s) 206b associated with the mobile devices 202, 204, and over a data communication channel of the network 206. In certain embodiments, the authentication server 206a and/or the network provider server 206b associated with the mobile device 202 can, based on, for example, user A's confirmation 270 to engage in encrypted messaging with a contact and/or phone number corresponding to the mobile device 204, use the contact information/phone number to identify (e.g., by performing one or more lookup or query operations) a network provider associated with the mobile device 204 (which may or may not be the same network provider associated with the mobile device 202), communicate with a corresponding network provider server 206b to trigger authentication of the mobile device 204 (or, where the mobile devices 202 and 204 are associated with the same network provider, such communication would not be necessary, and only triggering of the authentication may be performed), and cause the request to be transmitted to the mobile device 204 based upon authentication of the mobile device 204. Here, triggering authentication may involve causing an authentication app on the mobile device 204 to obtain information regarding the user B and/or the mobile device 204 (e.g., user B's name, SIM data (e.g., phone number, mobile device 204's serial number, and/or the like) stored in the mobile device 204, location data associated with the mobile device 204, data regarding a network access point to which the mobile device 204 is communicatively coupled, biometric information of user B, and/or the like), to provide the information to the network provider associated with the user B and/or the mobile device 204 for identity verification, and to obtain/generate encryption data (e.g., a private/public key pair) for the mobile device 204 based upon receiving confirmation from the network provider that the user B and/or the mobile device 204 have been verified. In some embodiments, the authentication server 206a and/or the network provider server 206b associated with the mobile device 202 may not yet trigger authentication of the mobile device 204, but may simply cause the request to be transmitted to the mobile device 204. In either case, the unrelated party may not receive the request, since the hacker's device does not correspond to the identified contact information/phone number and has no access to the authentication app on the mobile device 204.

As shown by reference number 278, the mobile device 204 may present a user interface querying the user B to accept or deny encrypted messaging, and may receive (280) a user selection to accept encrypted messaging (e.g., a depressing of icon A/E, although other user interfaces and user interaction techniques can be utilized as described herein). In embodiments where authentication of the mobile device 204 has already been performed (as described above), the authentication app on the mobile device 204 may utilize the obtained/generated encryption data for handshaking purposes, as described below. In embodiments where authentication of the mobile device 204 has not yet been performed, the authentication app on the mobile device 204 may obtain/generate encryption data by triggering authentication of the mobile device 204 and/or the user B in a manner similar to that described above with respect to reference numbers 272 and 274 for the mobile device 202 and the user A. Authentication of the mobile device 204 and/or the user B can ensure that subsequent handshaking/exchanging of encryption data for the messaging will (e.g., only) be between the intended parties/devices—i.e., the mobile device 202 and the mobile device 204. It should be appreciated and understood, therefore, that in the scenario where the malicious actor uses a hacking device to, for example, spoof the phone number associated with the mobile device 204 to “listen in”, and the user A of the mobile device 202 (or the user B of the mobile device 204) chooses to encrypt the messaging (e.g., to trigger authentication of the other party), the hacking device would not be authenticated by the network provider associated with the mobile device 204, and thus would not be able to participate (282b) in the handshaking/exchanging of encryption data for the messaging.

At 282a, the mobile devices 202, 204 may perform a handshake or exchange of encryption data (e.g., respective public keys or signatures). In various embodiments, the mobile devices 202, 204 may perform the handshake/exchange via one or more tokens. In one or more embodiments, the exchange may be conducted (e.g., in the form of data/text message(s) or the like) via the authentication server 206a and/or the network provider server(s) 206b associated with the mobile devices 202, 204, over a data communication channel of the network 206. In exemplary embodiments, handshaking may involve the authentication app on mobile device 202 signing exchange data using a private key (e.g., based on identity verification of the mobile device 202 by the network provider server 206b associated with the mobile device 202), and sending, via the network provider server(s) 206b associated with the mobile devices 202, 204, the exchange data to a device corresponding to the target recipient number (e.g., phone number). Here, the network provider server 206b associated with the target recipient number may identify the mobile device 204 (e.g., based upon prior registration of the mobile device 204 with the network-based authentication system), and provide the exchange data to the mobile device 204 to facilitate the handshake.

As shown in FIG. 2F, the mobile devices 202, 204 may, based upon successful handshaking, respectively present (283a, 283b) confirmation that encrypted messaging is being facilitated. As shown in FIG. 2G, the mobile device 202 may receive (284) a user input of a message to be transmitted to the mobile device 204, and may encrypt (286) the message. Here, for example, the mobile device 202 (e.g., the communications app and/or the authentication app operating on the mobile device 202) may encrypt the message using encryption data (e.g., a public key for the mobile device 204 obtained as part of the handshake). The mobile device 202 may cause (288a) the encrypted message to be transmitted to the mobile device 204, and the mobile device 204 may, after receiving the encrypted message, decrypt (290) the encrypted message and present (292) the decrypted message for the user B. In various embodiments, the mobile device 204 (e.g., the communications app and/or the authentication app operating on the mobile device 204) may decrypt the received encrypted message using encryption data for the mobile device 204 (e.g., a private key for the mobile device 204).

As shown by reference number 288b, while the unrelated party's (e.g., the hacker's) device might receive the encrypted message, it lacks the means to decrypt it. In this way, since the mobile devices 202, 204 are the (e.g., only) party devices with access to the corresponding encryption data, full end-to-end encrypted messaging between users A and B can be achieved with no possibility or means of decryption and re-encryption of messages therebetween by a third party.

In some cases, a user—e.g., user A or B—may desire to encrypt select messages but not others and/or may desire to encrypt a call for (e.g., only) a certain amount of time. In one or more embodiments, therefore, a user device—e.g., the mobile device 202 or 204—may be capable of providing selective encryption of communications (e.g., based on user input or automatically). The user device may provide (e.g., via a user interface) user selectable option(s)/setting(s) that enable the user to specify whether encryption should apply to one message, a set of messages (e.g., the next several messages, such as the next five messages, the next ten messages, etc.), a portion of a call (e.g., the first minute of the call, the next five minutes of the call, etc.), and/or the like.

In various embodiments, the user device may be configured to automatically initiate encryption for calls/messaging. Initiating encryption may include, for example, performing one or more of steps 214, 216, 218, 224, 226, 272, 274, 276a, 276b, 282a, 283a, 283b, 286, 288a, and/or the like. In certain embodiments, the user device may initiate encryption periodically (e.g., once a day, once an hour, etc.), based on detecting unencrypted messaging or an unencrypted call being conducted, and/or the like.

In one or more embodiments, the user device may use one or more machine learning algorithms configured to learn a user's encryption selection patterns. For example, in some embodiments, the user device may provide information regarding a user's encryption selection patterns as input to one or more machine learning algorithms, which may perform machine learning to automate future determinations or predictions of upcoming needs for encryption. In certain embodiments, the machine learning algorithm(s) may monitor (e.g., over time using a variety of monitoring/analysis tools, such as facial/voice recognition algorithms, etc.) a user's behavior relating to encryption selections and detect/learn patterns, such as the user (e.g., always) enabling encryption for messaging or calls with a particular counterparty, the user not (e.g., never) enabling encryption for messaging or calls with another counterparty, the user enabling encryption prior to (e.g., within a threshold period of time prior to) the user audibly discussing or sending messages about determined sensitive matters (e.g., information regarding meeting dates, information regarding meeting locations, information regarding children/minors, information regarding business or work, etc.), the user (e.g., always) enabling encryption for received messages that include clickable links (or uniform resource locators (URLs)), and so on. In various embodiments, a message that contains a clickable/selectable link (e.g., URL) may be rejected (e.g., by the user device 202 or 204, the network-based authentication system, and/or the network provider server(s) 206b) in a case where the sending counterparty is not successfully authenticated or verified.

In one or more embodiments, the user device may refine a machine learning algorithm based on feedback received from a user of the user device and/or from one or more other devices (e.g., management device(s)). For example, the user of the user device and/or one or more management devices may provide feedback indicating whether predictions of upcoming needs for encryption, made by the machine learning algorithm based on new inputs, are accurate and/or helpful—e.g., the feedback may include the user manually disabling encryption if the user deems encryption unnecessary, the user uttering that the user is satisfied that encryption has been automatically enabled, and/or the like. When the feedback indicates that a particular prediction is accurate and/or helpful, the user device may configure the machine learning algorithm to make predictions of upcoming needs for encryption based on the particular prediction (e.g., to predict upcoming needs for encryption in a manner similar to that in which the particular prediction was made). When the feedback indicates that a particular prediction is not accurate or helpful, the user device may configure the machine learning algorithm to avoid predicting upcoming needs for encryption in a manner in which the particular prediction was made. In this way, the user device can predict upcoming needs for encryption based on a machine learning algorithm, which improves the accuracy of the predictions, and conserves processor and/or storage resources that may otherwise be used to generate and store rules for predicting upcoming needs for encryption.

In various embodiments, aspects of the authentication/encryption processes described herein can apply to communications (calls and messages) between more than two user devices. With more than two user devices, additional handshakes may be needed—e.g., for three users in a group, three handshakes may be needed amongst the corresponding user devices; for four users in a group, six handshakes may be needed; and so on. In the case of messaging, each message may be passed through the handshakes from the sender to each receiver. In the case of calls between more than two users, the number of callers on an encrypted line may be limited. In certain alternate embodiments, the group of users may be treated as a single entity, and each user in the group may be treated as one that is connected to the group (e.g., a “spoke” connected to the group). In these embodiments, a hosting service (which the users may not be able to control and may need to trust) may be utilized to host the communications of the group.

It is to be appreciated and understood that leveraging network provider system(s) associated with user devices to authenticate or verify identities of the devices, as described herein, enables parties corresponding to those devices to communicate with one another with the confidence of the identity of the party at each end of the communication. Thus, in certain embodiments, such as in cases where encryption may not be needed, but where identity verification of parties in a communication session is nevertheless desired, communications (e.g., calls or messages) between the parties' devices may be facilitated by the network provider system(s) without confirmations, handshakes, or the like. Here, the identity verification functionality can be analogous to a public/private key implementation, in that the target recipient phone number (e.g., associated with user B of mobile device 204) may be thought of as a public key, and a combination of the target recipient phone number and successful verification of the identity of the mobile device 204 can be thought of as a private key, such that parties in a communication session can have the confidence of who they truly are communicating with in the session.

It is to be understood and appreciated that the quantity and arrangement of devices, networks, and user interfaces shown in FIGS. 2A-2G are provided as an example. In practice, there may be additional devices, networks, and/or user interfaces, different devices, networks, and/or user interfaces, or differently arranged devices, networks, and/or user interfaces than those shown in FIGS. 2A-2G. For example, the systems 200 and/or 250 can include more or fewer devices, networks, and/or user interfaces, etc. Furthermore, two or more devices, networks, or user interfaces shown in FIGS. 2A-2G may be implemented within a single device, network, or user interface, or a single device, network, or user interface shown in FIGS. 2A-2G may be implemented as multiple devices, networks, and/or user interfaces. Additionally, or alternatively, a set of devices, networks, and/or user interfaces of the systems 200 and/or 250 may perform one or more functions described as being performed by another set of devices, networks, and/or user interfaces of the systems 200 and/or 250.

FIG. 2H depicts an illustrative embodiment of a method 295 in accordance with various aspects described herein. In some embodiments, one or more process blocks of FIG. 2H can be performed by a user device, such as the user device 202 or the user device 204. In some embodiments, one or more process blocks of FIG. 2H may be performed by another device or a group of devices separate from or including the user device, such as the network 206.

At 295a, the method can include receiving a command to initiate end-to-end encrypted communications between a device and a second device. For example, the user device 202 can, in a manner similar to that described elsewhere herein, perform one or more operations that include receiving a command to initiate end-to-end encrypted communications between a device and a second device.

At 295b, the method can include providing, over a network, information regarding the device to a network operator system for authentication of the device. For example, the user device 202 can, in a manner similar to that described elsewhere herein, perform one or more operations that include providing, over a network, information regarding the device to a network operator system for authentication of the device.

At 295c, the method can include obtaining, over the network and responsive to the providing the information, a confirmation of authentication of the device from the network operator system. For example, the user device 202 can, in a manner similar to that described elsewhere herein, perform one or more operations that include obtaining, over the network and responsive to the providing the information, a confirmation of authentication of the device from the network operator system.

At 295d, the method can include generating first encryption data based on the obtaining the confirmation of authentication of the device. For example, the user device 202 can, in a manner similar to that described elsewhere herein, perform one or more operations that include generating first encryption data based on the obtaining the confirmation of authentication of the device.

At 295e, the method can include causing a portion of the first encryption data to be transmitted, over the network, to the second device. For example, the user device 202 can, in a manner similar to that described elsewhere herein, perform one or more operations that include causing a portion of the first encryption data to be transmitted, over the network, to the second device.

At 295f, the method can include obtaining, over the network and from the second device, a portion of second encryption data that is generated based on a second confirmation of authentication of the second device. For example, the user device 202 can, in a manner similar to that described elsewhere herein, perform one or more operations that include obtaining, over the network and from the second device, a portion of second encryption data that is generated based on a second confirmation of authentication of the second device.

At 295g, the method can include conducting the end-to-end encrypted communications with the second device by causing first communication data, directed to the second device, to be encrypted using the portion of the second encryption data, receiving, over the network, second communication data that is encrypted using the portion of the first encryption data, and decrypting the second communication data using a different portion of the first encryption data. For example, the user device 202 can, in a manner similar to that described elsewhere herein, perform one or more operations that include conducting the end-to-end encrypted communications with the second device by causing first communication data, directed to the second device, to be encrypted using the portion of the second encryption data, receiving, over the network, second communication data that is encrypted using the portion of the first encryption data, and decrypting the second communication data using a different portion of the first encryption data.

In some implementations of these embodiments, the first communication data and the second communication data comprise data packets corresponding to a voice call or SMS/MMS messages between the device and the second device.

In some implementations of these embodiments, the information comprises data regarding a location of the device, data regarding a subscriber identity module (SIM) associated with the device, biometric data associated with a user of the device, or a combination thereof.

In some implementations of these embodiments, the second confirmation of authentication of the second device is performed by the network operator system.

In some implementations of these embodiments, the second confirmation of authentication of the second device is performed by a different network operator system.

In some implementations of these embodiments, the causing the portion of the first encryption data to be transmitted to the second device is based on the second confirmation of authentication of the second device.

In some implementations of these embodiments, the first encryption data comprises a first pair of keys including a first public key and a first private key, the portion of the first encryption data comprises the first public key, and the different portion of the first encryption data comprises the first private key. In some implementations of these embodiments, the second encryption data comprises a second pair of keys including a second public key and a second private key, and the portion of the second encryption data comprises the second public key.

In some implementations of these embodiments, the obtaining the portion of the second encryption data, and the causing the first communication data to be encrypted using the portion of the second encryption data, prevents a third-party device from deciphering the first communication data.

In some implementations of these embodiments, the device is pre-registered with the network operator system to facilitate the providing the information regarding the device and the obtaining the confirmation of authentication of the device.

While for purposes of simplicity of explanation, the respective processes are shown and described as a series of blocks in FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

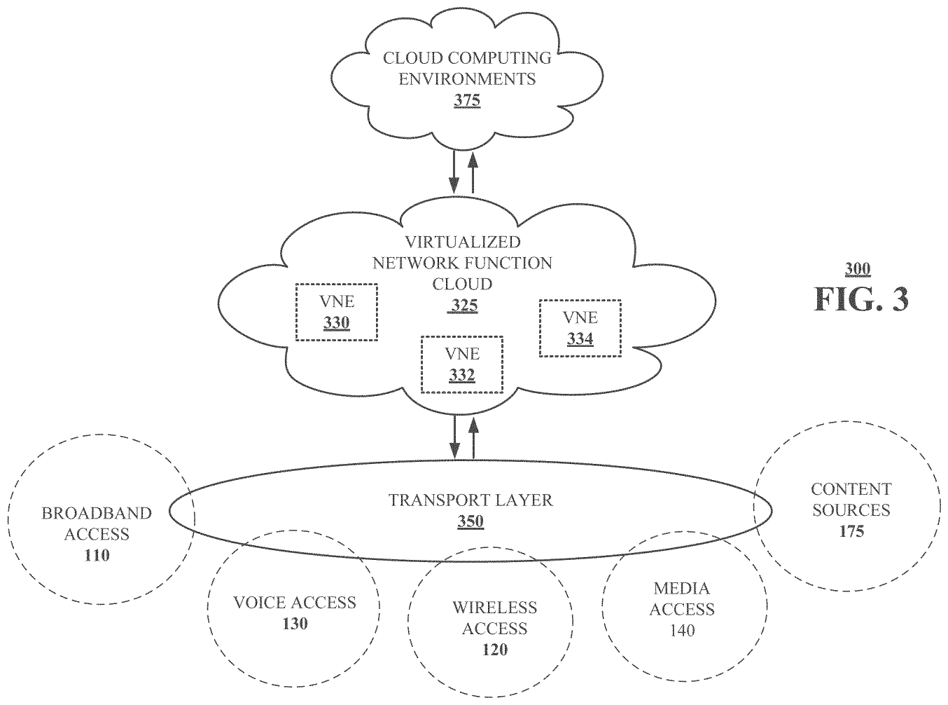

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of systems 200 and/or 250, and method 295 presented in FIGS. 1 and 2A-2H. For example, virtualized communications network 300 can facilitate, in whole or in part, end-to-end encryption of communications over a network, such as that described herein with respect to FIGS. 2A-2G.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

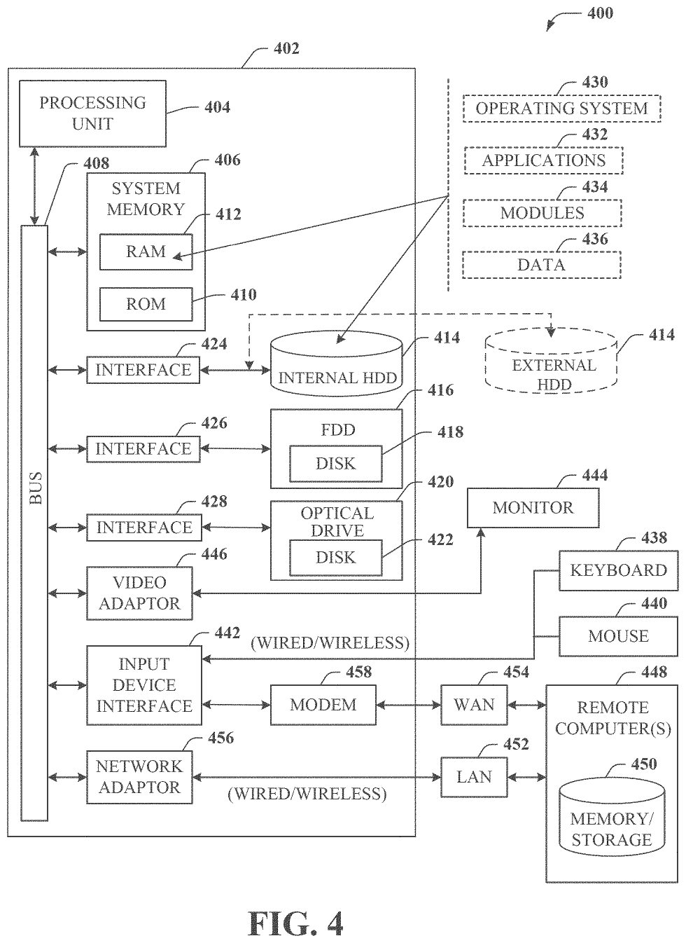

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, end-to-end encryption of communications over a network, such as that described herein with respect to FIGS. 2A-2G.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

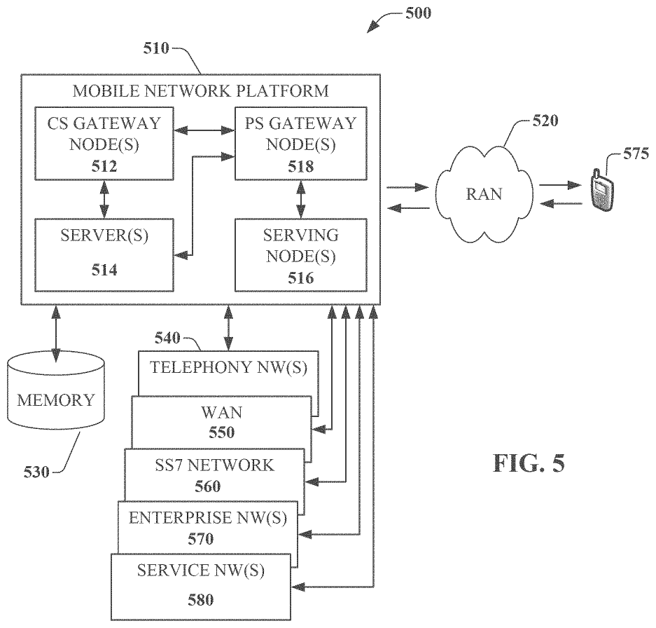

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, end-to-end encryption of communications over a network, such as that described herein with respect to FIGS. 2A-2G. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

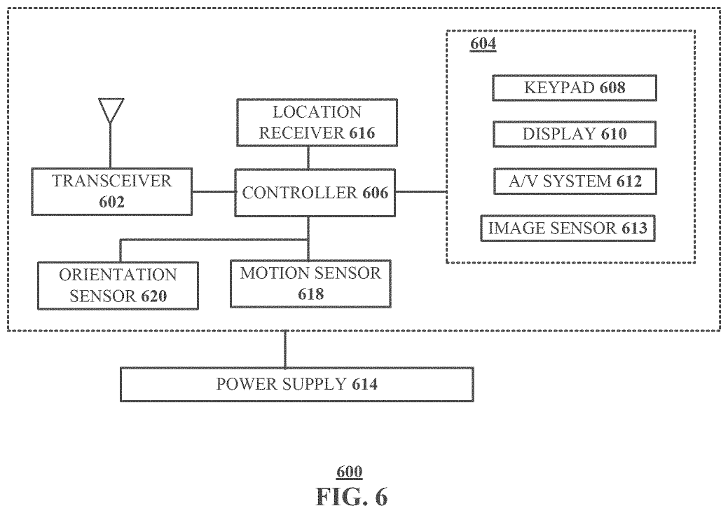

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate, in whole or in part, end-to-end encryption of communications over a network, such as that described herein with respect to FIGS. 2A-2G.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(×1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a command to initiate end-to-end encrypted communications between the device and a second device;
providing, over a network, information regarding the device to a network operator system for authentication of the device;
obtaining, over the network and responsive to the providing the information, a confirmation of authentication of the device from the network operator system;
generating first encryption data based on the obtaining the confirmation of authentication of the device;
causing a portion of the first encryption data to be transmitted, over the network, to the second device;
obtaining, over the network and from the second device, a portion of second encryption data that is generated based on a second confirmation of authentication of the second device; and
conducting the end-to-end encrypted communications with the second device by causing first communication data, directed to the second device, to be encrypted using the portion of the second encryption data, receiving, over the network, second communication data that is encrypted using the portion of the first encryption data, and decrypting the second communication data using a different portion of the first encryption data, wherein the end-to-end encrypted communications between the device and the second device correspond to one of a voice call, a video call, or a text message.

2. The device of claim 1, wherein the conducting the end-to-end encrypted communications is performed via a communications app executing on the device, wherein the receiving the command comprises receiving, via a user interface provided by the communications app, a user selection of an encryption option that is associated with an authentication app executing on the device, and wherein the authentication app is distinct from the communications app.

3. The device of claim 1, wherein the information comprises data regarding a location of the device, data regarding a subscriber identity module (SIM) associated with the device, biometric data associated with a user of the device, or a combination thereof.

4. The device of claim 1, wherein the second confirmation of authentication of the second device is performed by the network operator system.

5. The device of claim 1, wherein the second confirmation of authentication of the second device is performed by a different network operator system.

6. The device of claim 1, wherein the causing the portion of the first encryption data to be transmitted to the second device is based on the second confirmation of authentication of the second device.

7. The device of claim 1, wherein the first encryption data comprises a first pair of keys including a first public key and a first private key, wherein the portion of the first encryption data comprises the first public key, and wherein the different portion of the first encryption data comprises the first private key.

8. The device of claim 7, wherein the second encryption data comprises a second pair of keys including a second public key and a second private key, and wherein the portion of the second encryption data comprises the second public key.

9. The device of claim 1, wherein the obtaining the portion of the second encryption data, and the causing the first communication data to be encrypted using the portion of the second encryption data, prevents a third-party device from deciphering the first communication data.

10. The device of claim 1, wherein the device is pre-registered with the network operator system to facilitate the providing the information regarding the device and the obtaining the confirmation of authentication of the device.

11. A non-transitory machine-readable medium, comprising executable instructions that, when executed by a processing system of a mobile device including a processor, facilitate performance of operations, the operations comprising:
receiving a request to initiate end-to-end encrypted communications with a counterparty device, wherein the end-to-end encrypted communications correspond to one of a voice call, a video call, or a text message;
transmitting, over a network, information regarding the mobile device to a network operator system for verification of the mobile device;
receiving, over the network and responsive to the transmitting the information, a confirmation of verification of the mobile device from the network operator system;
deriving encryption data based on the receiving the confirmation of verification of the mobile device;
performing, over the network, a handshake with the counterparty device based on the encryption data; and
conducting the end-to-end encrypted communications with the counterparty device based on the performing the handshake, thereby avoiding unauthorized deciphering of the communications by any third-party devices.

12. The non-transitory machine-readable medium of claim 11, wherein the conducting the end-to-end encrypted communications is performed via a communications app executing on the mobile device.

13. The non-transitory machine-readable medium of claim 12, wherein the receiving the request comprises receiving, via a user interface provided by the communications app, a user selection of an encryption option that is associated with an authentication app executing on the mobile device, and wherein the authentication app is distinct from the communications app.

14. The non-transitory machine-readable medium of claim 11, wherein the receiving the request is via a network-based authentication system that communicates, over the network, with the network operator system.

15. The non-transitory machine-readable medium of claim 11, wherein the information comprises data regarding a location of the mobile device, a subscriber identity module (SIM) associated with the mobile device, or a combination thereof.

16. A method, comprising:
obtaining, by a processing system including a processor, and from a first user device, information regarding the first user device for authentication of the first user device, wherein the obtaining the information is responsive to a user request at the first user device to initiate encrypted calling or messaging between the first user device and a second user device;
performing, by the processing system, authentication of the first user device based on the information; and
responsive to the performing the authentication of the first user device, providing, by the processing system, and to the first user device, a confirmation of authentication of the first user device, wherein the providing the confirmation of authentication enables the first user device to exchange encryption data with the second user device to facilitate the encrypted calling or messaging with the second user device.

17. The method of claim 16, wherein the information comprises data regarding a location of the first user device, a subscriber identity module (SIM) associated with the first user device, or a combination thereof.

18. The method of claim 16, wherein the encrypted calling or messaging comprises end-to-end encrypted calling or messaging.

19. The method of claim 16, further comprising:
obtaining, by the processing system, and from the second user device, second information regarding the second user device for authentication of the second user device; and
performing, by the processing system, second authentication of the second user device based on the second information.

20. The method of claim 19, further comprising, responsive to the performing the second authentication of the second user device, providing, by the processing system, and to the second user device, a second confirmation of authentication of the second user device, wherein the providing the second confirmation of authentication enables the second user device to exchange the encryption data with the first user device to facilitate the encrypted calling or messaging with the first user device.
